(19) United States
(12) Patent Application Publication
(10) Pub. No.: US 2024/0409439 A1
(43) Pub. Date: Dec. 12, 2024

(54) System and Method for Environmental Management of Carbon Dioxide in Water Systems

(71) Applicant: Vycarb Inc., Brooklyn, NY (US)

(72) Inventors: Frank Garrett Boudinot, Brooklyn, NY (US); David Wigder, Brooklyn, NY (US); Lindsey Dukles, Brooklyn, NY (US); Jason Glover, Brooklyn, NY (US); Matthew Pfeiffer, Brooklyn, NY (US); Benjamin P. Smith, Brooklyn, NY (US)

(21) Appl. No.: 18/736,199

(22) Filed: Jun. 6, 2024

Related U.S. Application Data
(60) Provisional application No. 63/506,757, filed on Jun. 7, 2023.

(51) Int. Cl. C02F 1/00; B01D 53/14; C02F 1/68; C02F 101/10; C02F 103/00; C02F 103/08; C02F 103/34

(52) U.S. Cl. CPC C02F 1/008; B01D 53/1412; B01D 53/1475; B01D 53/1493; C02F 1/687; B01D 2252/1035; B01D 2257/504; B01D 2258/06; C02F 2101/10; C02F 2103/007; C02F 2103/08; C02F 2103/34; C02F 2201/005; C02F 2209/02; C02F 2209/05; C02F 2209/07; C02F 2209/22; C02F 2209/24; C02F 2209/40

(57) ABSTRACT

An example system for processing liquid to change an amount of carbon dioxide in the liquid includes a container including an inlet to receive liquid and an outlet to release the liquid and the container for holding the liquid, one or more sensors coupled to the container to measure carbon content in the liquid that is held in the container, and a control system including a processor for executing instructions to: receive outputs of the one or more sensors, and based on the outputs of the one or more sensors, control dosing of material into the container that reacts with carbon dioxide to change the amount of carbon dioxide in the liquid such that an amount of the material introduced into the container changes over time responsive to changes in the carbon content being measured in the liquid.

### CROSS REFERENCE TO RELATED APPLICATION

The present disclosure claims priority to U.S. provisional application No. 63/506,757, filed on Jun. 7, 2023, the entire contents of which are incorporated herein by reference.

### FIELD

This disclosure relates generally to the field of water treatment, and more specifically, to a new and useful system and method for environmental management of carbon dioxide in water systems.

### BACKGROUND

The increase in atmospheric greenhouse gas concentrations is a critical issue that has far-reaching environmental and social consequences. The need to reduce these gas concentrations has led to the development of a range of carbon dioxide removal technologies, including the pumping of supercritical carbon dioxide into rock formations for mineral precipitation. While these approaches hold significant promise, scaling them up to achieve meaningful reductions in atmospheric greenhouse gases presents significant challenges. Additionally, there are challenges in making carbon capture and sequestration solutions that can be low cost, accountable, and easily scaled.

Thus, there is a need in to create a new and useful system and method for environmental management of carbon dioxide in the field (e.g., in atmosphere and in water systems). Examples herein provide such new and useful systems and methods.

### SUMMARY

In one example, a system for processing liquid to change an amount of carbon dioxide in the liquid is described. The system comprises a container including an inlet to receive liquid and an outlet to release the liquid, and the container for holding the liquid. The system comprises one or more sensors coupled to the container to measure carbon content in the liquid that is held in the container, and a control system including a processor for executing instructions to: receive outputs of the one or more sensors, and based on the outputs of the one or more sensors, control dosing of material into the container that reacts with carbon dioxide to change the amount of carbon dioxide in the liquid such that an amount of the material introduced into the container changes over time responsive to changes in the carbon content being measured in the liquid.

In another example, a system for processing liquid to change an amount of carbon dioxide in the liquid is described. The system comprises a container including a first inlet to receive liquid into the container and a second inlet to incorporate gas into the liquid within the container, one or more sensors coupled to the container to measure carbon content in the liquid that is held in the container, and a control system including a processor for executing instructions to: receive outputs of the one or more sensors, and based on the outputs of the one or more sensors, control dosing of material into the container that reacts with carbon dioxide to change the amount of carbon dioxide in the liquid such that an amount of the material introduced into the container changes over time responsive to changes in the carbon content being measured in the liquid.

In another example, a method for processing liquid to change an amount of carbon dioxide in the liquid is described. The method comprises receiving liquid from a source into a container, measuring carbon content in the liquid that is held in the container by one or more sensors coupled to the container, and based on outputs of the one or more sensors, controlling dosing of material into the container that reacts with carbon dioxide to change the amount of carbon dioxide in the liquid such that an amount of the material introduced into the container changes over time responsive to changes in the carbon content being measured in the liquid.

The features, functions, and advantages that have been discussed can be achieved independently in various examples or may be combined in yet other examples. Further details of the examples can be seen with reference to the following description and drawings.

### BRIEF DESCRIPTION OF DRAWINGS

Examples, objectives and descriptions of the present disclosure will be readily understood by reference to the following detailed description of illustrative examples when read in conjunction with the accompanying drawings, wherein:

FIG. 1 illustrates a workflow diagram of an example of a system for processing liquid to change an amount of carbon dioxide in the liquid, according to an example implementation.

FIG. 2 illustrates a workflow diagram of another example of the system for processing liquid to change an amount of carbon dioxide in the liquid, according to an example implementation.

FIG. 3 illustrates an example of the system in use, according to an example implementation.

FIG. 4 illustrates a workflow diagram of an example of use of the system for processing liquid to change an amount of carbon dioxide in the liquid, according to an example implementation.

FIG. 5 illustrates a workflow diagram of another example of use of the system for processing liquid to change an amount of carbon dioxide in the liquid, according to an example implementation.

FIG. 6 illustrates a workflow diagram of another example of use of the system for processing liquid to change an amount of carbon dioxide in the liquid, according to an example implementation.

FIG. 7 illustrates a workflow diagram of another example of use of the system for processing liquid to change an amount of carbon dioxide in the liquid, according to an example implementation.

FIG. 8 illustrates a workflow diagram of another example of use of the system for processing liquid to change an amount of carbon dioxide in the liquid, according to an example implementation.

FIG. 9 illustrates a workflow diagram of another example of use of the system for processing liquid to change an amount of carbon dioxide in the liquid, according to an example implementation.

FIGS. 10A-10C are a set of schematic representations of different variations for how alkalinity may be introduced into the container for improved dissolution of alkalinity to optimize the carbon removal and storage outcomes of the system.

FIG. 11 is a schematic representation of the system in FIGS. 10A-10C using sensors to optimize the carbon removal and storage outcomes of the system.

FIGS. 12A-12C are another set of schematic representations of different variations for how alkalinity may be introduced into the container for improved dissolution of alkalinity to optimize the carbon removal and storage outcomes of the system.

FIGS. 13A-13C are a set of schematic representations of different system variations for optimizing introduction of alkalinity and carbon for improved dissolution and carbon capture kinetics.

FIG. 14 is a schematic representation of using temperature to enhance modification of a water system for improved dissolution and carbon removal and storage outcomes, according to an example implementation.

FIG. 15 is a schematic illustration of an example of a housing coupled to or including the container, the one or more sensors, and the control system, according to an example implementation.

FIG. 16 is a conceptual representation of the system of FIG. 15 for submersion into water bodies.

FIG. 17 is a schematic representation of the housing of FIG. 15 in a form of a floating vessel, such as a barge.

FIG. 18 is a method for processing liquid to change an amount of carbon dioxide in the liquid, according to an example implementation.

FIG. 19 is an example of a computer architecture diagram of one implementation of the system.

### DETAILED DESCRIPTION OF THE EMBODIMENTS

The following description of the embodiments of the invention is not intended to limit the invention to these embodiments but rather to enable a person skilled in the art to make and use this invention.

### Overview

Systems and methods for a waterway environmental management system discussed herein function to enable an aqueous (or water) processing system. The systems and methods may have various environmental management capabilities within water/aqueous systems.

The systems and methods leverage an implementation whereby an input from a water source or some aqueous system (e.g., river, ocean water, industrial waste system) enters a management receptacle or container, a sensing system monitors a set of chemical conditions (e.g., measuring of CO2, HCO3, CO3) of the water, active introduction of additive is performed during monitoring (e.g., pre-dissolved alkalinity is added while measurement tech measures the reaction (CO2->HCO3+CO3)), active introduction of the additive is ended upon satisfaction of target chemical conditions, and a water or aqueous output is released to the water or aqueous system.

The systems and/or methods may involve a fully, partially, or un-submerged water treatment tank (i.e., a management receptacle), and sensor systems to determine CO2 concentration, pH, temperature, and other parameters. Outputs of the sensor systems may be used to determine the amount and rate of CO2 in the entering (pre-treated) waters and in the effluent or discharge of an output of treated waters, enabling a quantitation of the volume of CO2 captured and stored as non-gas carbon forms (e.g., bicarbonate and carbonate ions).

Herein, the systems and methods are primarily discussed as applied to water systems, where one or more management receptacles receives input water and discharges output water. However, the system may reasonably be modified for use on other aqueous systems as applicable such as waste systems from or within industrial processing systems.

Systems and methods are applicable to a continuous flow, or batch, or combined batch and continuous flow aqueous processing system that enables carbon dioxide reduction (CDR) from water (or from air or concentrated CO2 if percolated into this system). An example purpose of this system is to sequester large quantities of CO2 into bicarbonates and carbonates, including by adding alkaline elements (e.g., Mg, Ca, Na, K, etc.) to water as products of dissolution of alkalinity-containing minerals, brines, materials, or waters.

The systems and methods enable a water-based carbon storage solution for direct water capture, direct air capture, and/or point-source captured carbon using alkaline materials in water. In various embodiments, the systems and methods may be adapted to enable or facilitate solutions for direct air capture, carbon capture and storage, eutrophication/oxygenation management, and/or other applications of environmental system management.

In addition to dynamically modifying water systems, the systems and methods also enable accurately and consistently measuring aqueous carbon concentrations and other chemical conditions to more precisely and accurately control modifications. The measurement approach may control the containment duration, flow rate, and alkalinity dissolution speed, and addition of materials into water to: a) inhibit over-alkalinization (dissolution/addition of alkalinity) that would lead to precipitation of solid carbonate minerals, potential negative impacts on biological systems, and/or inefficient/overcostly use of additive, b) prohibiting precipitation of solid carbonate minerals (which could emit CO2 in some aqueous systems), c) reduce alkalinity introduction when pre-treated water chemistry is low in CO2 or high in alkalinity, and/or d) increase alkalinity introduction when pre-treated water is of higher CO2/lower alkalinity. The measurement approach manages potential risk to the environment from water discharged back into the environment based on pH, temperature, the saturation state of carbonate materials, concentration of unreacted alkalinity, and other factors.

The systems and methods may be generally implemented as part of any closed or open water source for water monitoring and management. For closed systems, the systems and methods may be used to monitor and maintain water quality (e.g., reservoirs). For open systems, the systems and methods may enable fluid management in conjunction with other activities that occur on that body of water. For example, the systems and methods may be implemented in regions where waste is released, near mining operations, factory operations, heavy transport routes, and/or in other areas.

In some variations, the systems and methods may be performed in-situ in waters. An example system takes the form of a hydrodynamic system designed to be placed in a current or tidal area. Another example system is designed to float at surface using air or buoy systems or other systems that would allow it to stay partially submerged or rested/fixed to the riverbed/seabed or coastal infrastructure. The depth profile of the waters input and output from the system could be optimized or determined by the depth of the system relative to the flotation mechanism or static infrastructure that the system is adhered/attached to, as well as to target depths of the water column with highest CO2. Such a system would include a way to allow water to flow into and out of the system, and allow for a closed system to enable batch reaction. The system also allows for clearing of sediment at a bottom of a tank such that alkaline materials do not fully dissolve, preventing sediment from entering discharged water and enabling recovery of those materials for external disposal or economically viable use otherwise.

In one example, the systems and methods are used in connection with a water way such as a river, stream, or tidal estuary. The systems and methods may be used for monitoring and active adjustment of water conditions within the water way.

In another example, the systems and methods are used within an industrial water system, such as a mining operation. In this variation, the systems and methods are used for treating the water used in the mining operation and in some variations, also used for storing carbon that was captured from point-source emissions or ambient air (direct air capture).

In some variations, the systems and methods are used on land or above water (e.g., if this is placed on a ship or shore) in a container that holds water, allows flow-through of water, and/or discharges water into surface waters, soils, sediments, below-ground water reservoirs, groundwater, or other water treatment receptacles. The systems and methods may include different variations that can be used individually or in combination.

The systems and methods may provide a number of potential benefits and capabilities. The systems and methods are not limited to always providing such benefits and are presented only as exemplary representations for how the system and method may be put to use. The list of benefits is not intended to be exhaustive and other benefits may additionally or alternatively exist.

As one potential capability and/or benefit, the systems and methods are used for alkalinity/silicate/material water removal (via dissolution) and/or waste discharge neutralization. The systems and methods are used to facilitate removing solid or liquid alkaline waste by neutralizing with CO2, in concentrated form or air, and by accelerating the dissolution of the material with mechanical, thermal, and chemical processes.

As another potential capability and/or benefit, the systems and methods enable a form factor for natural water in-situ carbon reduction, measurement, and/or management. For example, a system and method variation may use a submerged tank form factor within a natural water system. The systems and methods may additionally use wave or flow energy (e.g., from tides and currents) to increase process energy efficiency. For example, wave or flow energy may be used for dissolution of additives, filling a receptacle, and/or emptying/discharging a receptacle.

As another potential capability and/or benefit, some variations of the systems and methods enable direct air capture capabilities. Active pumping or passive intake of ambient air may enable direct air capture by reacting CO2 in air with alkaline waters to form HCO3 in water. This may function to leverage an increased carbon storing capacity of high alkaline waters to enable capture of ambient-air CO2.

As another potential capability and/or benefit, variations of the systems and methods are used for water acidification mitigation. The systems and methods may target natural waters and avoid incorporation of additional CO2, which may enable the mitigation of acidification from local and global forcings. Measurement-driven alkalinity addition enables this to be responsive to natural CO2 and pH variability. This may enable uses of the systems and methods in aquaculture, ecosystem management and restoration, as well as water quality management, wastewater, and industrial water management.

As another potential capability and/or benefit, variations of the system and method mitigate deoxygenation risks. In some variations, active mixing and incorporation of air (not just concentrated CO2) or other oxygen sources may re-oxygenate air, and thus provides an application for mitigating deoxygenated waters (which are also acidic, as Org C+O2->CO2).

As another potential benefit, the systems and methods leverage monitoring headspace CO2 and water chemistry to calculate dissolved CO2. This may be a lower cost sensing solution that may additionally use less energy and materials.

As another potential benefit, the systems and methods include variations leveraging active alkalinity dissolution. In some variations, a silo may hold an additive, whereby gravity facilitates addition. Dissolution may be accelerated using physical, thermodynamic, and/or chemical changes (e.g., mixing, aeration, heating, CO2 incorporation at site of mixing). Rates may change based on type of alkalinity, material particle size, and pH of the water into which it is being dissolved.

As another potential benefit, the systems and methods use measurement-driven alkalinity addition. This may enable precision alkalinity addition. Alkalinity addition may be increased when CO2 or acidity is high and decrease alkalinity addition when CO2 or acidity is low. Decreasing when acidity is low (e.g., pH is high) mitigates risk of carbonate precipitation (e.g., a net CO2 emission). This may also provide a more targeted solution that adapts to natural temporal and spatial variability in the environment.

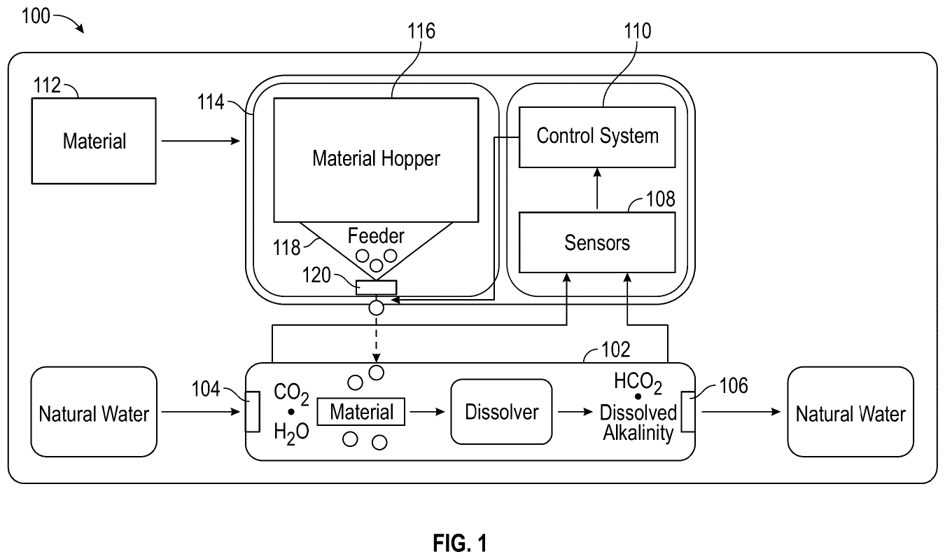

Referring now to the Figures, FIG. 1 illustrates a workflow diagram of an example of a system 100 for processing liquid to change an amount of carbon dioxide in the liquid, according to an example implementation. The system 100 includes a container 102 including an inlet 104 to receive liquid and an outlet 106 to release the liquid. The container 102 is for holding the liquid for processing. The system 100 also includes one or more sensors 108 coupled to the container 102 to measure carbon content in the liquid that is held in the container 102. The system also includes a control system 110 including a processor for executing instructions to: receive outputs of the one or more sensors 108, and based on the outputs of the one or more sensors 108, control dosing of material 112 into the container 102 that reacts with carbon dioxide to change the amount of carbon dioxide in the liquid such that an amount of the material 112 introduced into the container 102 changes over time responsive to changes in the carbon content being measured in the liquid.

The container 102 may take many forms, and in one example, holds liquid in a range of about 70 L of liquid (for a small closed system) to 2.5 million liters (for a large closed system, e.g., size of swimming pool area), and can be larger or smaller sizes depending on placement and configuration needs. Thus, the container 102 functions as a tank or other form of receptacle where detection and/or treatment of water is processed. The container 102, when in an open state, allows the liquid to flow into and out of the container, and in a closed or operating state, prevents gaseous and liquid flow into or out of the management receptacle.

The container 102 receives liquid, such as water from a water source or some aqueous system (e.g., river, ocean water, industrial waste system). The inlet 104 and the outlet 106 are in communication (wired or wireless) with the control system 110, such that the control system 110 controls opening and closing of the inlet 104 and the outlet 106 based on signal transmission.

Thus, the inlet 104 is used to receive pre-treated water, and the outlet 106 is used to release water (which, following processing is treated water). In some variations, the inlet 104 and the outlet 106 are integrated to take advantage of a natural flow of a surrounding water system, such as a flow of a water river or stream or waves from a body of water. Thus, the inlet 104 and the outlet 106 can be the same defined opening through which water is received or discharged. In some variations, the inlet 104 and the outlet 106 have valves or doors that passively or actively control flow in and/or out.

The control system 112 is in communication with the inlet 104 and the outlet 106 to control opening and closing of the inlet 104 and the outlet 106.

The sensors 108 are shown coupled to the container 102 to receive samples of the liquid in the container 102. In an example implementation, illustrated in other figures described below, the sensors 108 are positioned inside the container 102 to measure various chemical conditions of the liquid (e.g., measuring of CO2, HCO3, CO3). The control system 110 is in communication (wired or wireless) with the sensors 102 to receive outputs of the sensors to determine amounts of carbon dioxide in the liquid.

The sensors 108 thus function to monitor a state of the fluid extracted from an external water system. In one example, the sensors 108 include a spectroscopic sensor and/or other sensors to measure properties of gas and/or liquid portions inside the container 102. The sensors 108 are situated to measure properties of an appropriate portion of the container 102 (i.e., gas sensors are situated in the gas portion and liquid sensors are situated in the liquid portion). In an example, the spectroscopic sensor is preferably attuned and positioned to measure carbon compounds in the gas portion of the measuring receptacle. More specifically, the spectroscopic sensor is attuned to detect and measure common carbon compounds in gas, such as carbon dioxide. In one example, the spectroscopic sensor is a non-dispersive infrared (NDIR) sensor.

In other examples, additional sensors are included such as a temperature sensor, a pressure sensor, a pH sensor, an alkalinity sensor, a flow meter, an electrical conductivity sensor, a refraction sensor (e.g., refractometer), a specific gravity sensor (e.g., hydrometer), and/or a hygrometer. Depending on the liquid for measurement and other environmental conditions, other sensors may be incorporated as well. The sensors 108 function to measure specific quantities of chemicals, and can work in conjunction to determine more complex fluid properties, such as viscosity and salinity.

The control system 110 is also in communication with an additive system 114 that is coupled to the container 102 including a repository of the material 112 (e.g., in a material hopper 116) to be added into the container 102. The additive system 114 includes a feeder 118 and a valve 120, and the control system 110 is in communication (wired or wireless) with the valve 120 to control operation of the valve 120 of the feeder 118 to release the material 112 from the feeder 118 into the container 102.

The additive system 114 functions to facilitate manipulation and/or modification of the liquid. Different variations of additives may be used. In one variation, the additive system 114 includes a repository of additive compound or material that may be deposited or otherwise added to a fluid. The additive system 114 may additionally include components to facilitate mixing. In some variations, multiple different additive compounds or materials are added (together or individually). In some variations, the system and/or the additive application system includes other components to facilitate modification of a water system.

In an example operation, the control system 110 controls active introduction of the material 112 into the container 102 to neutralize an amount of carbon dioxide in the liquid in the container 102. Thus, the control system 110 receives outputs of the one or more sensors 108, determines a carbon dioxide content of the liquid in the container 102, determines an amount of the material 112 to release into the container 102 in order to react with the carbon dioxide in the liquid, and then controls the valve 120 to do so. During introduction of the material 112 into the container 102, the sensors 108 continue to output data indicative of the chemical conditions of the liquid so that the control system 110 controls, in real time, amounts of additional material to add to the liquid.

In another example operation, the control system 112 controls opening and closing of the inlet 104 and the outlet 106 to control flow rate of liquid into and out of the container 102. The flow rate of the liquid into and out of the container 102 affects the carbon dioxide reaction with the material 112, such that a slower flow rate allows more carbon dioxide in the liquid to react with the material. As such, based on outputs from the sensors 108, the control system 112 modifies the flow rate accordingly (to optimize neutralization of CO2 in the liquid) by controlling opening and closing of the inlet 104 and the outlet 106.

In still another example operation, the control system 112 controls opening and closing of the inlet 104 and the outlet 106 to control dwell time/duration of the liquid in the container 102. The duration of the liquid in the container 102 affects the carbon dioxide reaction with the material 112, such that a longer duration allows more carbon dioxide in the liquid to react with the material. As such, based on outputs from the sensors 108, the control system 112 modifies the duration of the liquid in the container 102 (to optimize neutralization of CO2 in the liquid) by controlling opening and closing of the inlet 104 and the outlet 106.

The control system 110 thus functions to facilitate computer-controlled operation of the system 100. Various control approaches may be used to facilitate operation, as described herein. In some variations, the operation of one aqueous processing system may rely on data-driven operation based on external factors. In some variations, the operation of a plurality of aqueous processing systems may be coordinated such that they are operated as a network.

The system 100 may additionally include a power system. The power system may any suitable type of power system. In some variations, the power system may include or otherwise utilize current/tidal movement, river flow, gravity, solar photovoltaic (PV), and/or other non-renewable energy sources.

The material 112 includes powdered minerals, in one example, such as one of an alkaline element (e.g., magnesium (Mg), calcium (Ca), sodium (Na), potassium (K), etc.). Thus, the control system 110 monitors the chemical reaction (CO2->HCO3+CO3) during active introduction of the additive.

In one example, the container 102 includes a dissolver (e.g., mixer) to assist with dissolving the material 112 in the liquid to increase the speed of conversion of carbon dioxide to HCO3. In other examples, the material added includes pre-dissolved alkalinity based liquid, where the alkaline element is dissolved in water forming alkaline water that is then added to the liquid in the container 102.

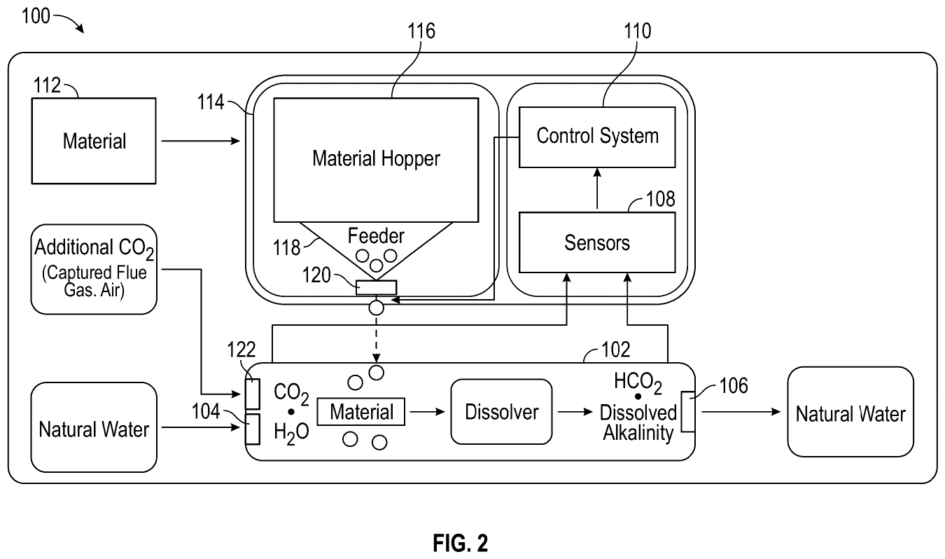

FIG. 2 illustrates a workflow diagram of another example of the system 100 for processing liquid to change an amount of carbon dioxide in the liquid, according to an example implementation. In FIG. 2, the container 102 includes the inlet 104 as a first inlet to receive liquid into the container 102, and a second inlet 122 to incorporate gas into the liquid within the container 102. Thus, the second inlet 122 is an air inlet to enable direct air capture (or other gases to enable carbon capture and storage (CCS) or carbon storage (CS)) into the container 102 to incorporate gas into the liquid within the container 102. In this example, the control system 110 receives outputs of the sensors 108, and based on the outputs of the sensors 108, controls dosing of the material 112 into the container 102 that reacts with carbon dioxide to change the amount of carbon dioxide in the liquid such that an amount of the material introduced into the container 102 changes over time responsive to changes in the carbon content being measured in the liquid. The control system 110 further controls the second inlet 122 to enable the direct air capture (or other gases) that incorporates air from any number of sources, such as external atmosphere, exhaust or flue gas from an emissions source, or storage that includes externally captured carbon dioxide. The air captured into the container 102 will be incorporated into the liquid in the container 102 to increase the carbon dioxide in the liquid. As such, the control system 110 then controls dosing of the material 112 into the liquid to neutralize the carbon dioxide in the liquid, for example, resulting in an overall effect of carbon capture.

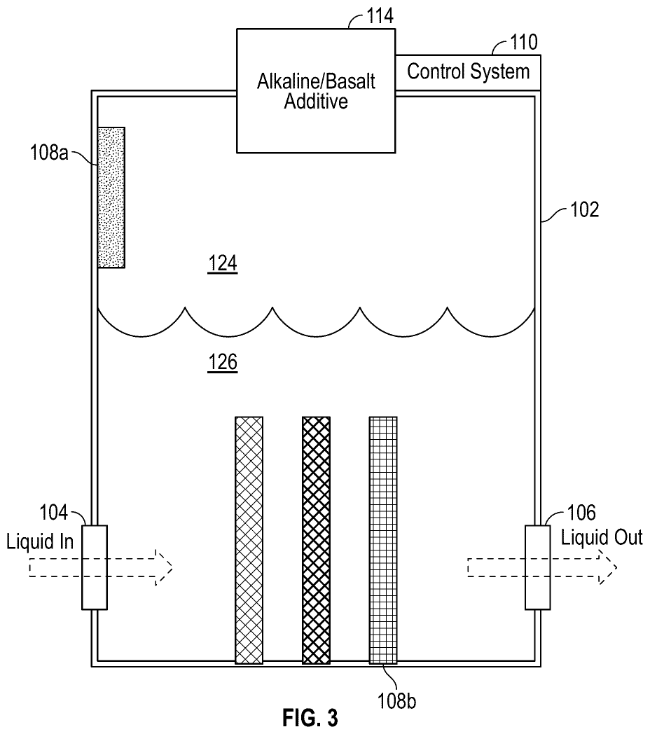

FIG. 3 illustrates an example of the system 100 in use, according to an example implementation. The system 100 functions as a monitoring device that once partially filled with the liquid, and in a closed state, detects and measures carbon content of the liquid. The closed state prevents liquid and airflow into or out of the container 102, and thus, the inlet 104 and the outlet 106 are closed in the closed state.

The container 102 is functionally divided into two portions: a top portion 126 (also referred to as a gas portion or non-filled region); and a bottom portion 124 (also referred to as the liquid portion or filled region). As used herein, the terms top portion and bottom portion (or gas and liquid portions) are generally functional designations that suggest a level that the container 102 is partially filled to function. That is, the top portion 124 and the bottom portion 126 do not necessarily suggest a different construction between the top portion 124 and the bottom portion 126, but an approximate level that the container 102 needs to be filled with a liquid to function. In some variations, these different regions may be separate.

In an example operation, the container 102 is partially filled with the liquid, and sensors 102a positioned in the top portion 124 measure gaseous carbon concentration measurements in the top portion 124 of the container 102. Other sensors 108b positioned in the bottom portion 126 measure general properties of the liquid (e.g., salinity, pH, and temperature). Outputs of the sensors 102a-b are used by the control system 110 to determine the liquid carbon concentration.

In another example, in FIG. 3, the top portion 126 is useful for air being percolated into the water in the bottom portion 124, such that the container 102 becomes entirely filled with water with a higher partial pressure of CO2.

The system 100 is particularly useful for measuring and/or monitoring carbon compound concentrations in water. As a major contributor of carbon in water is carbon dioxide, the system 100 enables measuring and monitoring of carbon dioxide in water. In the same manner, the system 100 may be implemented to measure carbonate (CO3) and bicarbonate (HCO3) concentrations (or their conjugate acids, carbonic acid (H2CO3)). Generally, the system 100 may be implemented to measure fluctuations of these compounds (or other carbon compounds) in any fluid, and potentially determine the specific concentrations of each of these carbon compounds within the fluid.

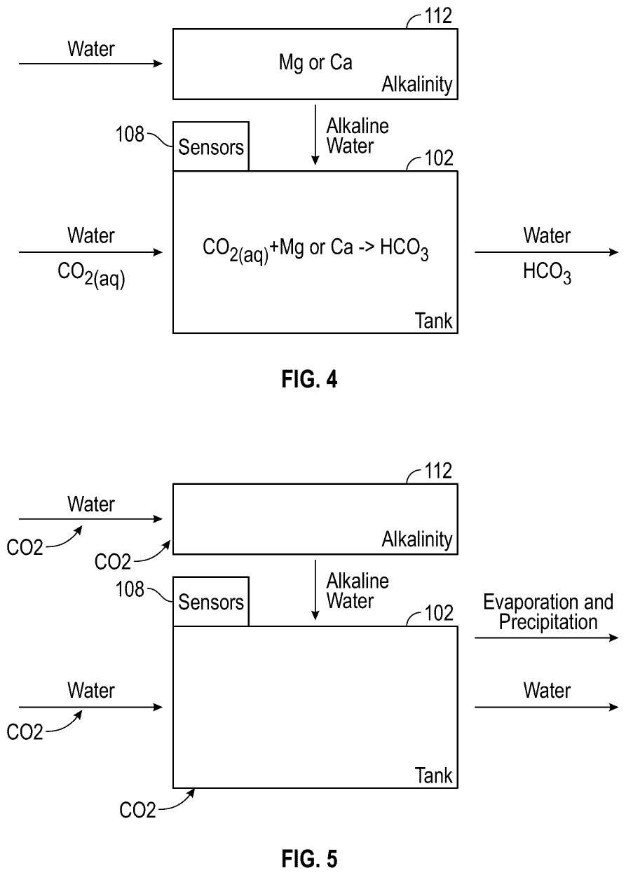

The monitoring capabilities or any similar monitoring capability may then be used in combination with various components for actively modifying a state of the water system. This may be used for different applications such as carbon storage, direct air capture, eutrophication, and/or other applications. Examples of different applications are described below with reference to FIGS. 4-14.

FIG. 4 illustrates a workflow diagram of an example of use of the system 100 for processing liquid to change an amount of carbon dioxide in the liquid, according to an example implementation. In FIG. 4, the system leverages an implementation whereby an input from a water source or some aqueous system (e.g., river, ocean water, industrial waste system) enters the container 102, the sensors 108 monitor a set of chemical conditions and output data of measurements for CO2, HCO3, and CO3, active introduction of additive (e.g., Mg or Ca in powder from or pre-dissolved in water for alkaline water) is performed during monitoring while measuring a carbon dioxide conversion reaction, introduction of the alkalinity additive is ended when a target level of CO2 is removed, a water or aqueous output is released to the water or aqueous system.

In one example, introduction of the material into the container 102 is ended based on the material 112 reacting with the carbon dioxide in the liquid and the amount of carbon dioxide in the liquid being below a threshold amount (e.g., based on measurements received from the sensors over time). Initially, the carbon content in the liquid is measured at a first content, and dosing of the material 112 into the container 102 changes the amount of carbon dioxide in the liquid to a second content lower than the first content. Outputs of the sensors 108 during active introduction of the material 112 into the container 102 determine when the second content is reached.

In some examples, introduction of the material 112 into the container 102 ends based on a target amount of carbon dioxide being removed from the liquid. An amount of carbon dioxide captured and stored is determined based on a comparison of the first content and the second content levels. The outlet 106 of the container 102 is opened, based on signals from the control system 110, to release the liquid based on the amount of carbon dioxide in the liquid falling below a threshold amount.

FIG. 5 illustrates a workflow diagram of another example of use of the system 100 for processing liquid to change an amount of carbon dioxide in the liquid, according to an example implementation. In FIG. 5, the system is used for carbon capture and/or storage. For example, carbon dioxide is shown being incorporated into the liquid in the container 102 either by direct air capture into the container 102 or by introduction into the container 102 from the material 112 (e.g., CO2 is added to the alkaline water being introduced into the container 102 or directly into input water before entering the container 102 or alkalinity tank). In some variations, the CO2 may be pre-captured and provided by an outside supply. In other variations, the system and method may include systems and/or processes for capturing CO2 from flue gases or other CO2 containing gas sources.

In some applications, this variation may be used for in-line water treatment for industrial water discharge. Pre-captured carbon dioxide is then incorporated into the water. This may be performed: before the treated water enters the container 102 (e.g., larger water container), before water enters the alkalinity chamber (e.g., where the material 112 is stored), in the container 102 (where the alkalinity has already been added), or into the tank where the material 112 is stored. This is preferably implemented before or in the tank so that carbon storage efficacy can be measured and monitored.

The carbon dioxide may come from direct air capture/some other carbon removal source. The carbon dioxide may additionally or alternatively come from captured carbon from a point-source (e.g., fossil fuel emissions).

The carbon dioxide may come in range of purity. When the carbon dioxide purity is high, then this may enhance or help accelerate dissolution of alkalinity. Using higher purity or processing CO2 supply to increase purity may additionally have other performance enhancements such as making the system and method operate faster (dissolution of materials occurs more quickly and more efficiently) and/or needing less volume of gas to incorporate.

In one example, an alkalinity source is preferably used to facilitate capturing of carbon within the water. The alkalinity source could be alkaline water, a solid, or any other suitable alkalinity source.

Within examples, a gas incorporation mechanism such as a percolation, injection, aeration, or other suitable system is used to incorporate the carbon dioxide into the water with the alkalinity source to cause the transformation and capture of carbon within the water/fluid.

The treated water may be managed in one or more different ways. In one variation, treated water may then be discharged into surface water (as a means to neutralize alkaline water discharge). In another variation, treated water may be recirculated into more alkalinity until full neutralization/all CO2 is converted to HCO3 (to further reduce CO2 and more CO2 is converted to HCO3). Thus, in some variations, not all CO2 is converted, but additional cycles can be performed if desired for full conversion. In another variation, the treated water may be evaporated or otherwise removed to precipitate carbonate minerals.

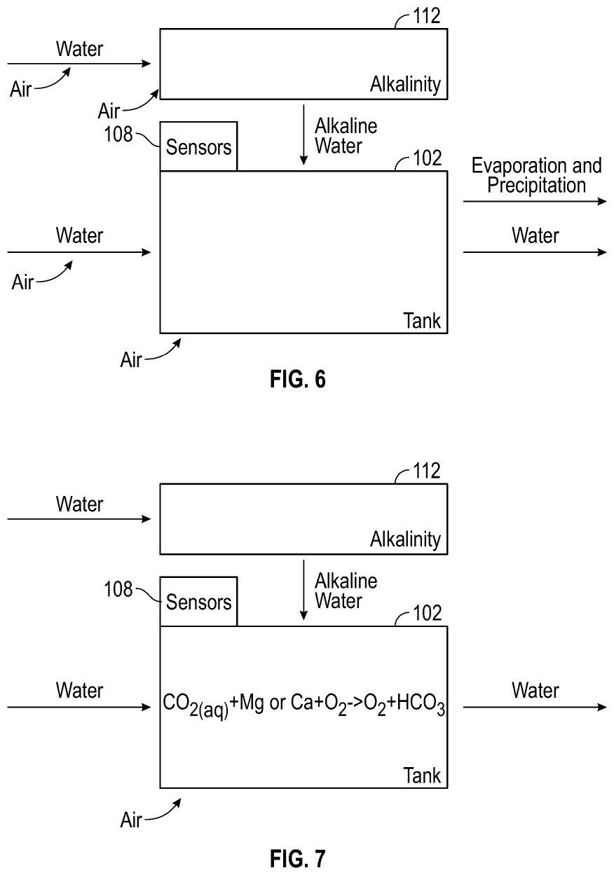

FIG. 6 illustrates a workflow diagram of another example of use of the system 100 for processing liquid to change an amount of carbon dioxide in the liquid, according to an example implementation. In FIG. 6, the system is further configured for direct air capture as a form of carbon capture and/or storage by incorporating carbon dioxide, either pure or in a gaseous mixture such as ambient air or flue gas, into the water.

This variation enables carbon dioxide to be extracted from air and stored within water as carbonate. This can function similarly to the carbon capture systems and method variations described herein, but with incorporation of air. If a range of carbon dioxide in the carbon storage scenario (above) becomes low enough (e.g., down to 400 ppm CO2), then ambient air can be incorporated into water to increase addition of carbon dioxide. The sensors 108 monitor levels of carbon dioxide in the container, and based on outputs of the sensors, additional ambient air is incorporated to reach desired/configurable levels of carbon dioxide in the container 102.

Continuous or repetitive incorporation of low-concentration carbon dioxide streams, like ambient air (e.g., 400 ppm CO2), into an already-mineralized water solutions may increase the total dissolved carbon concentration in the form of bicarbonate and carbonate. Over time, this could measurably reduce the concentration of carbon dioxide from the atmosphere, providing a direct air capture technology with integrated storage.

In the example of FIG. 6, the system optionally includes an air control mechanism that functions to incorporate air into the processing and treatment of water for carbon storage. In one variation, the air control mechanism could be or include a pump. The pump may be used where the water is static, and air is circulated through the water. In another variation, the air control mechanism may utilize water movement and mixing. The design of the system could allow or promote water turbulence to incorporate air into the water. The water mixing may be artificially introduced using some agitator. The water mixing may alternatively be promoted through a design that utilizes waves, water flow, or natural motion to promote agitation of water. For example, a design of the tank (e.g., a higher surface area to volume ratio) also promotes incorporation of air into water.

FIG. 7 illustrates a workflow diagram of another example of use of the system 100 for processing liquid to change an amount of carbon dioxide in the liquid, according to an example implementation. In FIG. 7, the system is used for oxygenation and/or other applications where incorporation of air can provide a water-quality improvement, like for mitigating eutrophication. The sensors 108 comprise a first sensor for measuring the carbon content in the liquid, and a second sensor for measuring an oxygen level of the liquid in the container 108, and based on the oxygen level of the liquid in the container 102, the control system controls the air inlet (e.g., shown in FIG. 2 for use of incorporating CO2, and also, can be used to incorporate air) to enable the direct air capture into the container 102 to incorporate additional oxygen into the liquid within the container.

In some variations, the system mitigates water acidification from both local eutrophication and organic matter respiration (e.g., increasing CO2 and thus carbonic acid) or climate change-driven acidification (e.g., from atmospheric CO2 increase, or ocean upwelling) in waters. The active incorporation of air into the water for carbon uptake may have the added benefit of re-oxygenating (aerating) the water, providing an environmental and water quality benefit in many water systems.

Because eutrophication/respiration consumes oxygen to generate CO2, the added benefit of aeration and reoxygenation of the system could provide dual benefits to water quality and ecosystem health as an “end-of-pipe” solution to nutrient runoff, organic waste runoff, acidification, and hypoxia/anoxia/deoxygenation. The carbon removal and mineral waste components may then be ancillary benefits. The control by measurement would allow the process to be responsive to ecological and environmental fluctuations that lead to temporal changes in pH, oxygen, and CO2.

Some variations may incorporate air into alkaline water. Variations may include incorporation of air compressors into the water chamber, the alkalinity addition chamber, the inlet or outlet of either the alkalinity or water chamber. Air could be re-circulated between the alkalinity and water chamber for increased efficiency. The system and method may take advantage of the temperature difference and be incorporated specifically into the cold, and more gas-soluble, waters phase. The systems and methods may leverage gravity flow of water from one chamber to another, or within a component of the system, or within a separate component, that incorporates ambient air into the cascade of falling water. The systems and methods may incorporate air into the active pumping of water from a submersible pump. It could serve to additionally increase the agitation and dissolution of alkaline minerals.

In one such variation, the systems and methods may be used to manage water oxygenation. This may be used in natural waters or other water systems (e.g., industrial water by-product planned for depositing into a natural water system) that suffer from low oxygen levels. Partially resulting from high CO2 levels, natural waters may also have low oxygen (both caused by respiration). Coupling oxygenation to carbon removal in water may have ecosystem benefits. The system and methods may enable a comprehensive solution for impacts of eutrophication/algal blooms.

The systems and methods may similarly address water acidification. High CO2 in waters can lower pH (e.g., carbonic acid). The systems and methods may include features to monitor and modify pH.

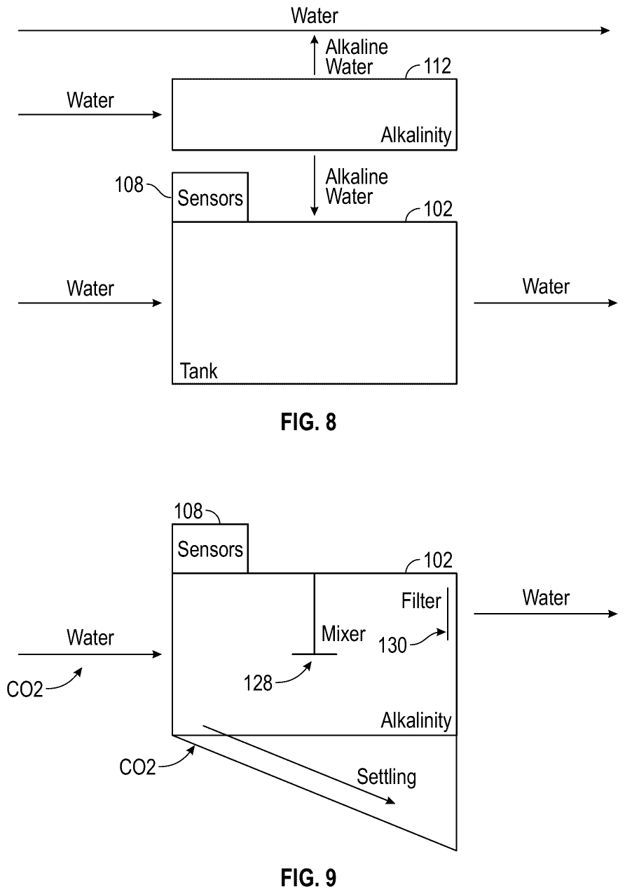

FIG. 8 illustrates a workflow diagram of another example of use of the system 100 for processing liquid to change an amount of carbon dioxide in the liquid, according to an example implementation. In FIG. 8, the system is configured to optimize the dissolution of certain alkaline materials to reduce alkaline material solid waste (e.g., mine tailings) and separation management. In a variation for addressing water acidification, the system facilitates flowing water entering the container 102, the sensors measuring CO2, HCO3, and/or CO3, and alkaline water being added at a known rate into the container 102. CO2 levels are being measured (in real time during introduction of the alkaline water) to quantify CO2 reduction, and alkaline water is added to an open water body or return to a source of the water based on a reaction rate of CO2 to alkaline water in the container 102. The container 102 may be refilled, and the process repeated regularly to continuously or periodically calibrate alkaline water addition into the water source. This variation may include an additional alkaline water line on the container 102 with flow into a larger system (open water body) that that can be controlled and/or monitored based on measurements and reactions in a smaller system (e.g., the container 102).

FIG. 9 illustrates a workflow diagram of another example of use of the system 100 for processing liquid to change an amount of carbon dioxide in the liquid, according to an example implementation. In FIG. 9, the system includes various component designs and/or processes to facilitate accelerated alkalinity dissolution. For example, the container 102 includes a separate or integrated mechanism for artificially mineralizing (increasing alkalinity of) the water by adding solid, fine-particle alkaline minerals to water with either physical agitation for physical weathering (e.g., such as through use of a mixer 128), or acid added to the water for chemical weathering.

One such method for acidifying water is by incorporating CO2 to increase the carbonic acid content of the water. Percolation of CO2 into treated water can also promote alkalinity dissolution through physical agitation of the solute. Ambient air containing CO2, and other gas streams of variable CO2 concentration, could be used to this effect.

The container 102 further includes a filter 130 coupled to or adjacent to the outlet to prevent undissolved additive from being released from the container 102.

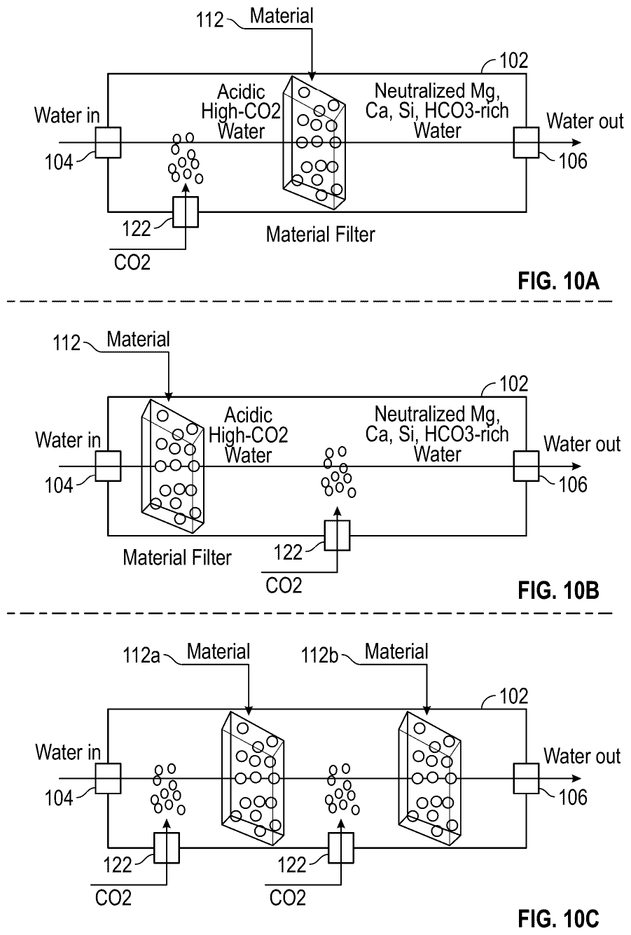

FIGS. 10A-10C are a set of schematic representations of different variations for how alkalinity may be introduced into the container 102 for improved dissolution of alkalinity to optimize the carbon removal and storage outcomes of the system. In the figures, basalt is referenced which could be any alkalinity source, and filters are referenced, but any material that traps or filters solid alkaline materials but allows dissolution may be used. Referenced CO2 may be captured CO2, air containing CO2 (e.g., a mixture of CO2 and O2), and/or any source of CO2. Added CO2 in different locations within the system may be used to increase the dissolution.

In FIG. 10A, water is input into the container 102 through the inlet 104 and carbon dioxide is also introduced into the water through the air inlet 122. This creates acidic, high-CO2 content water. The material 112 being added is in a form of a material filter (where the material may be basalt, for example) where the material is held inside the container 112 in a filter mechanism that allows water to filter through the container 102 and pass through the filter and continuously dissolve the material being held in the container 102. Addition of the material neutralizes the acidic water content forming HCO3-rich water, which is then released back to the water source through the outlet 106. Note that additional material 112 is added to the container 102, in some examples, based on dosing requirements determined from outputs of sensors.

In FIG. 10B, water is input into the container 102 through the inlet 104 and then passed through the basalt filter creating alkaline-rich water. Carbon dioxide is later introduced into the water through the air inlet 122 to neutralize the water content forming HCO3-rich water, which is then released back to the water source through the outlet 106.

In FIG. 10C, a two stage filtering system is utilized where water is input into the container 102 through the inlet 104, carbon dioxide is introduced into the water through the air inlet 122, and then the acidic, high-CO2 content water reacts with the material 112a being added. The material neutralizes the acidic water somewhat, and additional CO2 is added into the water with additional material 112b being added as well to eventually form HCO3-rich water, which is then released back to the water source through the outlet 106.

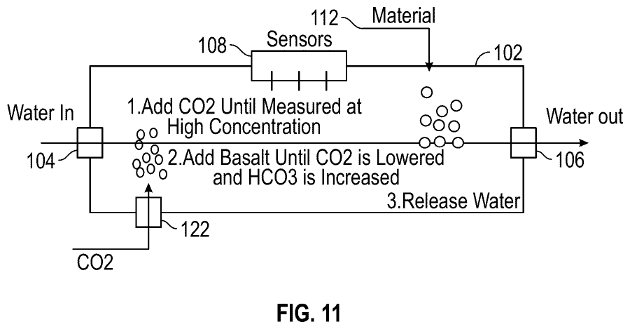

FIG. 11 is a schematic representation of the system in FIGS. 10A-10C using sensors to optimize the carbon removal and storage outcomes of the system. In FIG. 11, water is input into the container 102 through the inlet 104 and CO2 is added via the air inlet 122 until outputs of the sensors 108 indicate CO2 present in the liquid at high concentrations. Following, the material 112 (e.g., basalt) is added until measured CO2 in the liquid is lowered to a target/configurable amount, and HCO3 is increased. Last, the neutralized water is released back to the water source via the outlet 106.

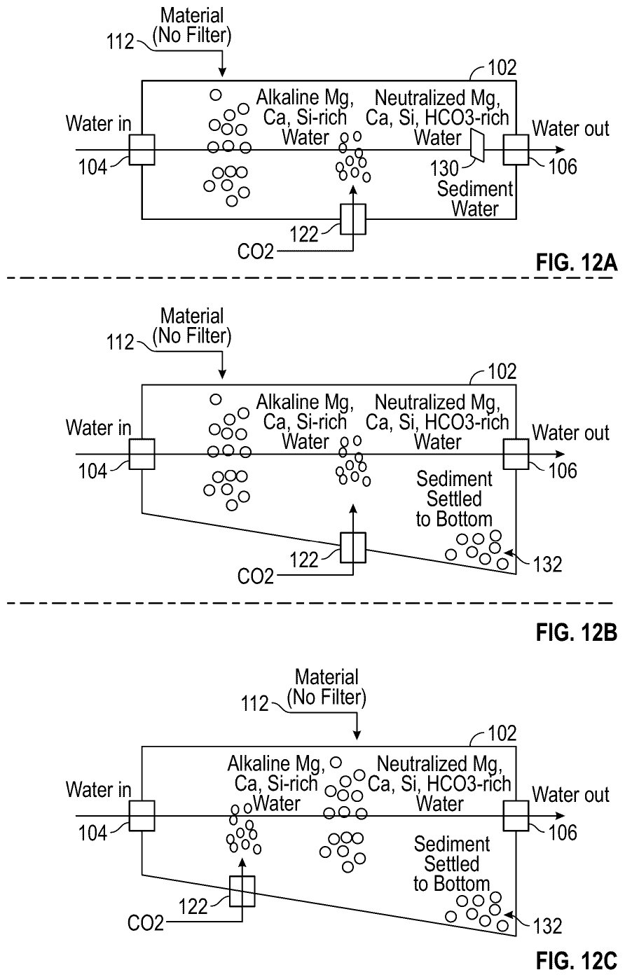

FIGS. 12A-12C are another set of schematic representations of different variations for how alkalinity may be introduced into the container 102 for improved dissolution of alkalinity to optimize the carbon removal and storage outcomes of the system. Examples shown in FIGS. 12A-12C are similar to that shown in FIGS. 10A-10C, except no internal filter is utilized. Rather, the material 112 is added into the container in a powder form. As such, in the example in FIG. 12A, the filter 130 is provided adjacent the outlet 106 to prevent undissolved material from being released out of the container 102. In the example in FIGS. 12B-12C, undissolved material added to the container 102 become sediment 132 settled to a bottom of the container 102. The sediment 132 is then removed and recovered over time.

In one example, the material 112 reacts with the carbon dioxide to dissolve and form bicarbonate products, and the control system 110 controls dosing of the material 112 such that some of the material 112 is recoverable and the amount of carbon dioxide in the liquid is reduced to a target amount. It may be, based on a type of material used, that full dissolution of the material is difficult to obtain. Thus, the control system 110 controls dosing such that an amount of the material is recoverable, e.g., the material 112 dissolves to about 50% and a remainder is recovered or reused. Thus, potential sediment accumulation and uneven dissolution can be taken into account to prevent release of sediment into outflowing water.

Thus, the systems and methods may include design features that optimize or enhance dissolution of alkaline materials, and their trapping within the system, to encourage full dissolution without sedimentation, water clouding, or other undesired impacts on the treated water as shown in variations of FIGS. 12A-12C. This could include the use of filtration, dual-system dissolution, mechanical mixing, agitation, acidification, gasification, gravitational settling, percolation, and any other water-mineral-gas introduction mechanism. Direct real-time measurements of the water chemistry would determine the outflow of water, inflow of minerals, and inflow of acids, CO2, and other gas to maintain optimum reaction rates by reducing alkaline saturation of the water.

The system and method may include other design features to address any resulting or residual sediment.

Accordingly, the system and method may be used to dissolve alkalinity material in an accelerated fashion. This may be used to facilitate dissolving alkalinity tailings from mining waters. In one such variation, a system may include a tank for holding solid alkalinity, a mixer, and filter. The system may be designed or configured to optimize or enhance dissolution and solid-liquid separation. For example, a beveled bottom may be used for collection of separation (e.g., as shown in FIGS. 12B-12C).

In one variation, alkalinity materials can be held in the container 102 (e.g., the management receptacle or another container stage of the aqueous processing system). Water is introduced to the container 102. CO2 may have been added to the water before it enters container 102. Alternatively, CO2 may be added to container 102 with alkalinity in it. A mixer is activated, which may help prevent flocculation and encourage dissolution.

Sensors of the sensor system measure CO2, HCO3, CO3 of water. If concentration of CO2 gas is incorporated and flow rate of incorporation is known, then CO2 storage may be calculated. The system and method may use various approaches to releasing the water while collecting the alkalinity, trapping the alkalinity, and/or otherwise mitigating loss of alkalinity to the outside water system. In one variation, the management receptacle or container may have a beveled bottom that holds alkalinity while allowing water is flowed or discharged from a top outlet. In another variation, the filter 130 (e.g., stainless steel mesh) could hold back solids. This variation can be part of/same as carbon storage described herein.

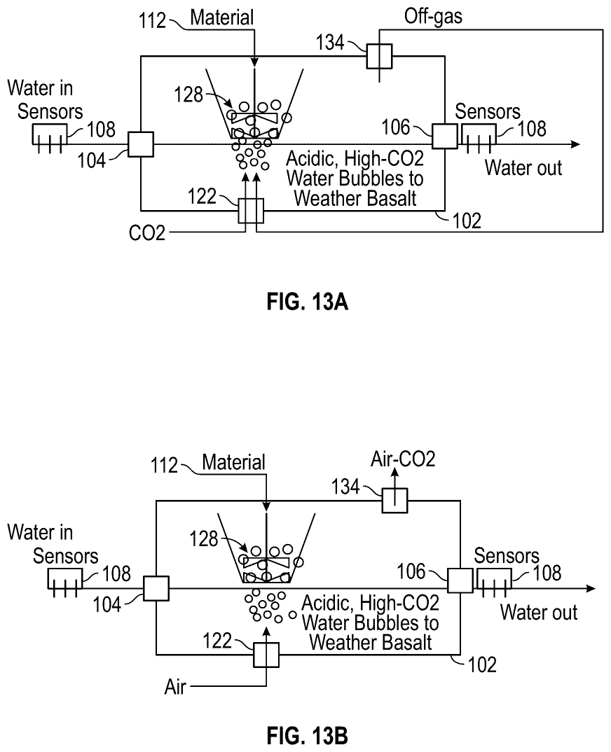

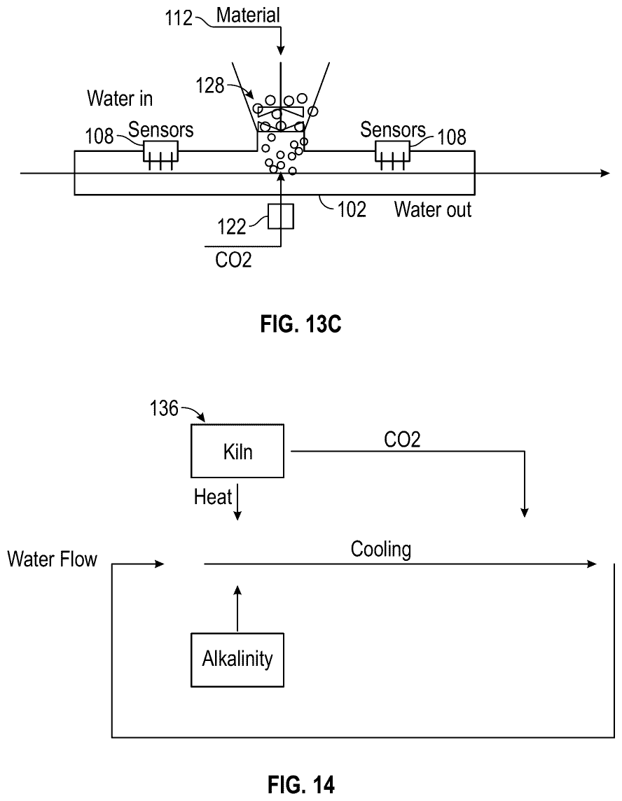

FIGS. 13A-13C are a set of schematic representations of different system variations for optimizing introduction of alkalinity and carbon for improved dissolution and carbon capture kinetics. In FIG. 13A, water is input and a first set of the sensors 108 measure carbon content of the water at the inlet 104. An amount of the material 112 is determined to optimize alkalinity and is combined through use of the mixer 128, in addition to introduction of high-CO2 through the air inlet 122. In this example, alkalinity and CO2 are added together and increase in CO2 is measured and controlled. Off-gas is released through a vent outlet 134 and returned to the air inlet 122 for repeating the process. A second set of sensors 108 is adjacent to the outlet 106 to measure an amount of carbon content in the liquid being released from the container 102. Outputs of the first and second sets of sensors are compared to determine an amount of carbon converted to HCO3, for example.

In a further example, a sensor is positioned adjacent to the vent outlet 134 to measure the CO2 concentration in the off-gas to further assist with calculating a net change in CO2 in the liquid.

In FIG. 13B, an alternative is shown where air is introduced into the container, and the vent outlet 134 outputs off-gas into the external atmosphere.

In FIG. 13C, another alternative is shown, where input water is a continuous flow, and no air off gassing, but the container 102 is open to release treated water on a back end.

FIG. 14 is a schematic representation of using temperature to enhance modification of a water system for improved dissolution and carbon removal and storage outcomes, according to an example implementation. For example, dissolution of alkaline minerals in water can be increased thereby increasing the solubility of CO2 in the water (the latter of which can increase the former) by leveraging temperature-dependence of CO2 solubility and mineral dissolution.

A temperature-swing approach is utilized that dissolves minerals in heated waters, cools those waters for incorporation of CO2, and potentially returning the cooled waters to high temperatures for further mineral incorporation (in a circular process) or discharging. The heat is generated from the same processes generating the CO2 for cold-water incorporation, including a kiln 136 in mineral processing plants, as shown in FIG. 14. The system takes advantage of the natural thermoclines to create temperature swings too. For example, the system and method may collect warmer surface water to dissolve minerals and incorporate CO2 into cooler water pumped from lower depths.

Examples of the system can take many forms, and may be configured as a boat, barge, or other type of floating, partially-submerged, or fully-submerged vessel, that is positioned in the water, on shore, or as a component of a boat.

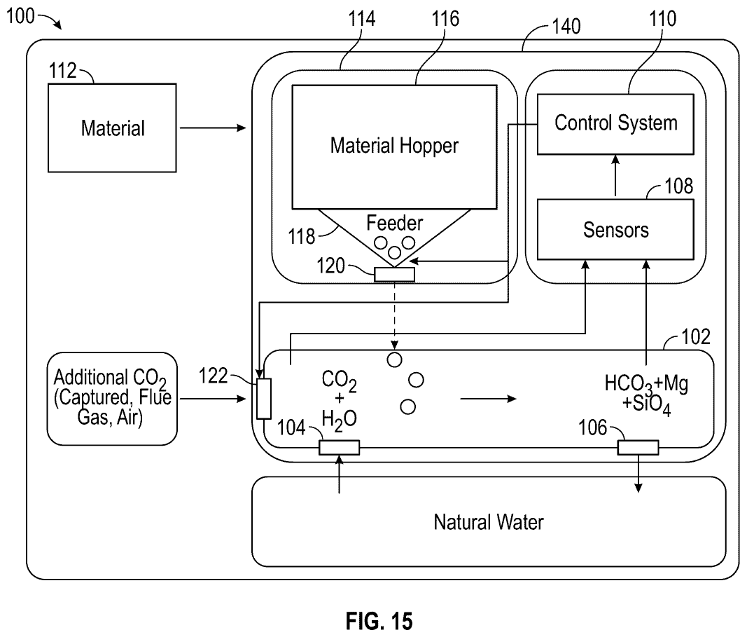

FIG. 15 is a schematic illustration of an example of a housing 140 coupled to or including the container 102, the one or more sensors 108, and the control system 110, according to an example implementation. Thus, all components are positioned inside a single housing. The housing 140 is at least partially submerged in a source of the liquid (e.g., natural water), such that the inlet 104 and the outlet 106 are submerged to receive and release water.

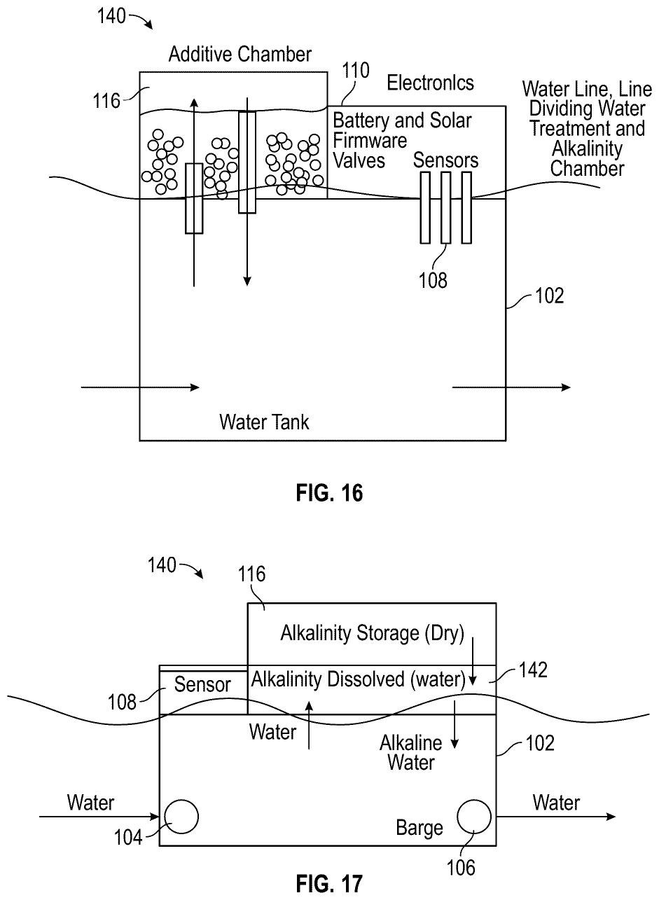

FIG. 16 is a conceptual representation of the system of FIG. 15 for submersion into water bodies. In FIG. 16, a portion of the housing 140 is submerged in water enabling water intake and release easily. The housing 140 can be floating, such as any type of floating vessel, or moored to land as well.

FIG. 17 is a schematic representation of the housing of FIG. 15 in a form of a floating vessel, such as a barge. The housing 140 is coupled to or includes the container 102, the one or more sensors 108, and the control system 110, and the housing is a floating vessel. In FIG. 17, the material hopper 116 is shown coupled to a tank 142 holding water to dissolve the material 112 forming alkaline water for introduction into the container 102 to neutralize carbon dioxide in liquid of the container 102.

The system is thus a mobile system designed to be a floating vessel. This vessel could be deployed and optionally directed around a water system, and could travel from an open water system for deployment to a shoreline for refilling of alkaline materials.

Using the measurement technology to detect areas of higher and lower pH, CO2, and oxygen, the system and method may include transporting the system to locations of increased acidification and CO2 to mitigate spatially-variable acidification and CO2. The mobility could also ensure that treated waters are not over-treated or re-treated in areas where flow or natural conditions would allow already-treated waters to re-enter the system.

The system's motion away and into untreated waters, determined by the measurement sensors, would increase efficacy and spatial scale of water treatment. A mobile variation of the system and method may incorporate any of the features and variations described herein.

In one exemplary implementation, the vessel may start at shore or docking position. Alkalinity is then added. The vessel then moves out to a targeted location (e.g., an area measured or expected to be a high CO2 waterway). Ports/valves/floodgates open in bottom area of the vessel to allow water into the entirety of a lower water-storage component. Separate internal valves may open to allow water into an upper alkalinity dissolution tank. Alkalinity supply (e.g., dry alkalinity source) may be dropped into the alkaline dissolution tank. Sensors measure CO2, HCO3, and/or CO3 in lower water tank. Alkaline water is dropped or transferred from the alkalinity dissolution tank into another tank (e.g., the lower water tank). Sensors can measure change in CO2, HCO3, and/or CO3. Water may then be released from lower tank. New water can be introduced, leveraging directional flow of natural water body (i.e., port/valve in front and back of vessel open simultaneously).

In such a variation, the vessel includes a bottom tank 102 or container that can be filled with water, a top tank 142 that can be filled with water plus an alkalinity source, a top deck or other container to hold alkalinity, an optional cover for the alkalinity source to keep it dry, and the sensors 108 to monitor the lower water tank. The vessel in some variations may include ports on front and back to enable directional flow for filling and/or emptying water. The vessel may include components and a design to make the vessel buoyant when filled with water. This may include an additional tank or vessel design to increase buoyancy for operation.

In some variations, a tank may be at or slightly below the water line when filled with water (based on the density of either freshwater or saltwater). This may maximize/increase the size of the cargo hold while minimizing/reducing an air gap and time to achieve equilibrium.

The top deck or other type of alkalinity source storage may include features to facilitate depositing or adding alkalinity materials. The vessel may include a funnel or other sloped mechanism for passively allowing alkalinity to fall into an alkalinity storage component and/or a dissolution chamber below, or could all be held in dissolution chamber at once immediately upon being added to vessel.

The form factor of the aqueous processing system may take on other various forms. The system and method could be stationary, dropped in to, moored on to, or placed in a single location.

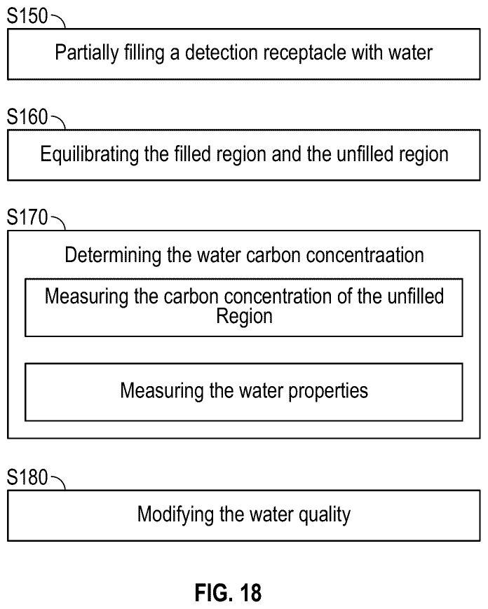

FIG. 18 is a method for processing liquid to change an amount of carbon dioxide in the liquid, according to an example implementation. At S110, the method includes partially filling a container or management receptacle with water, thereby creating a filled region containing water and an unfilled region containing air. Thus, the method includes receiving liquid from a source into a container.

At S160, the method optionally includes at the management receptacle, equilibrating the filled region and the unfilled region.

At S170, the method includes determining the water carbon concentration, such as by measuring carbon content in the liquid that is held in the container by one or more sensors coupled to the container. In another example, determining the water carbon concentration includes measuring, in the unfilled region, the carbon concentration and measuring, in the filled region, the water properties. The method functions to measure, and monitor over time, the carbon concentration of a body of water. That is, the method leverages specific properties of the body of water and carbon concentration of a gaseous region in equilibrium with a portion of that body of water, to determine the carbon concentration of the body of water. In some examples, with additional information regarding thermodynamic and molecular properties of some general, the method may be implemented to determine the carbon concentration of any fluid. The method may be implemented with a closed unmoving body of water (e.g., a lake), or an open dynamic body of water (e.g., river). The method may be used with the system as described but may be generally implemented with any appropriate system.

At S180, the method includes in response to the water carbon concentration, modifying the water quality. As an example, based on outputs of the one or more sensors, the method includes controlling dosing of material into the container that reacts with carbon dioxide to change the amount of carbon dioxide in the liquid such that an amount of the material introduced into the container changes over time responsive to changes in the carbon content being measured in the liquid.

The water management method functions to actively monitor and control the water quality. In addition to monitoring and modifying the water carbon concentration, the method may further control water quality by modifying water pH, water alkalinity, water mineral content, and water mineral quality (e.g., by the formation of salts).

Block S150, which includes partially filling a management receptacle with water, functions to acquire a sample of the body of water for analysis. Partially filling a management receptacle with water comprises filling the receptacle such that part of the receptacle is filled with water (i.e., the filled region, or water region), and part of the receptacle is empty (i.e., unfilled region, or air region). In some variations, block S150 is a single operation, and a single sample is taken. Alternatively, block S150 may comprise setting up the management receptacle such that water continuously travels through the filled region, whereas the unfilled region stays empty.

Block S120, which includes equilibrating the filled region and the unfilled region of the management receptacle, functions to allow the system to relax to a steady state. That is, the system is allowed to sit or settle until there is no net molecular exchange between the filled and unfilled regions of the management receptacle. For the system to reach this steady state, it may be required to seal the unfilled region (and possibly the filled region).

For a continuous flow implementation, the system may be prevented from reaching a steady state, as the unfilled region would be continuously replenished from the exterior environment.

Thus, for a continuous flow implementation of the filled region, the method may use a body of water for measurement that is sufficiently large that it may act as a reservoir, such that particulate concentration of the body of water is unaffected by reaching a steady state with the unfilled region of the management receptacle. Alternatively, for continuous flow implementation, a discrete sample of the water may be collected and held in a smaller system, such that the measurement is of specific time points that can be integrated to represent changes over time.

The time required for reaching a steady state may be implementation specific. Dependent on external environmental conditions (e.g., temperature, carbon disparity between air and water, etc.), the time required for equilibrating the filled region and the unfilled region may vary. In some new implementations, this time may be optimized by making an initial sample acquisition and monitoring the carbon fluctuations in the unfilled region. This may be done multiple times at different temperatures, to determine the time required at different times of day.

Block S170, which includes determining the water carbon concentration, functions to determine the desired output of the method. Determining the water carbon concentration includes measuring the carbon concentration of the unfilled region, and measuring the water properties. At steady state, the gaseous carbon concentration may be used in conjunction with the properties of the water to calculate the water carbon concentration.

Dependent on implementation, block S150 further determines the concentration of different molecular forms of carbon. That is, determining the water carbon concentration may further include determining the water carbon dioxide concentration, determining the water carbonate concentration, and determining the water bicarbonate concentration.

Measuring the carbon concentration of the unfilled region functions to measure the concentration of different gaseous carbon compounds in the unfilled region of the management receptacle. This may be done using a broad range of spectrometers. As the primary forms of carbon include carbon dioxide, carbonate, and bicarbonate, a spectrometer functioning in the infrared spectrum may be sufficient to measure the carbon concentration of the unfilled region.

Measuring the water properties functions to measure the targeted water properties of the body of water to enable calculation of the water carbon concentration. Measuring the water properties may include measuring the water temperature, water salinity, and water pH. Dependent on implementation, other water properties may also be measured. Measuring the water properties may occur within the management receptacle, but particularly in the case of large body of waters, may be implemented anywhere in the body of water that would have similar properties of the acquired sample.

Thus, in one example, block S170 includes measuring, by the one or more sensors positioned in the unfilled region, a carbon content of the air; measuring, by the one or more sensors positioned in the filled region, properties of the liquid including temperature, salinity, and alkalinity; and calculating the concentration of carbon in the liquid based on the outputs of the one or more sensors.

Block S180, which includes modifying the water quality, functions to alter the water composition, by altering the water pH, water alkalinity, and/or water carbon concentration. Modifying the water quality, may be in response to the measured water carbon concentration, or other water qualities, as measured by block S170.

Modifying the water quality may be implementation specific, and a desired water quality may be first input, and dependent on measurements from block S170, modifying the water quality makes changes accordingly to reach the desired water quality. For example, in an implementation where the local water is highly alkaline and mineral rich, modifying the water quality works to reduce the pH (e.g., by adding carbon dioxide). Adding CO2 then causes converting CO2 to HCO3 and CO3 (e.g., for storage). Thus, in this example, the method comprises measuring alkalinity of the liquid in the container by a sensor, and based on the alkalinity of the liquid in the container, controlling an inlet of the container to enable direct air capture into the container to incorporate additional carbon dioxide into the liquid within the container.

In another example, where the carbon concentration of the water is high and/or the water has a low pH, modifying the water quality adds alkaline compounds for increasing the pH, capturing/removing CO2 from the water.

In operation, the method may be used for optimizing carbon removal and storage. Accordingly, in some variations the method can include measuring CO2, HCO3, CO3, and if CO2 measurement satisfies some conditions (e.g., present above a threshold), then add alkalinity source. Alkalinity can be added while continuing measuring, and when CO2 levels satisfy some target condition (e.g., CO2 decreases to desired amount and/or pH reaches desired endpoint), stop adding alkalinity source. If the difference between beginning and ending of alkalinity addition is too large (e.g., took too long), this may signal a condition for adding more alkalinity.

The method may use various approaches to measuring conditions within the system. Measuring CO2 is preferably performed leveraging headspace, pH, and/or salinity. In some variations electrical conductivity (EC) may be used as proxy for salinity. EC may additionally or alternatively be used as proxy for alkalinity. In general, salinity does not change over course of alkalinity addition, but alkalinity does, so the method may use delta on before and after alkalinity addition treatment to calculate a true salinity level. EC can additionally or alternatively be used as proxy for alkalinity alone (by removing salinity and temperature signal).

In another variation, the method uses dissolved CO2 and pH to calculate Alkalinity, dissolved inorganic carbon (DIC), HCO3, and/or CO3.

In another variation, the method uses alkalinity and CO2 to calculate pH, DIC, HCO3, and/or CO3.

In another variation, the method uses alkalinity and pH to calculate CO2, DIC, HCO3, and/or CO3.

In some variations, the method may see differences between the three to triangulate “true” values and reduce the analytical and theoretical uncertainties that derive from each individual method.

The method thus performs live measurements to quantify a baseline CO2, HCO3, and CO3, and to quantify a post-removal CO2, HCO3, and CO3, and uses the data to control amounts of addition of alkalinity for optimized final CO2 output (˜425 ppm), HCO3 and CO3 based on the starting conditions. Thus, the method is executed to control dosing of material into the container to perform a feedback loop including (i) releasing a first amount of the material from the feeder into the container, (ii) receiving subsequent outputs of the one or more sensors, (iii) determining an updated carbon content in the liquid, (iv) based on the updated carbon content in the liquid being above a threshold amount, releasing a second amount of the material from the feeder into the container. In still another example, based on the updated carbon content in the liquid being above a threshold amount, the method includes changing a dwell time/duration of the liquid in the container or changing a flow rate of the liquid into/out of the container.

Within examples, the systems and methods of the embodiments are embodied and/or implemented at least in part as a machine configured to receive a computer-readable medium storing computer-readable instructions. For example, the control system 110 includes a processor for executing instructions to perform functions described herein. The instructions are executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions are executed by computer-executable components integrated with apparatuses and networks of the type described above. The computer-readable medium is stored on any suitable computer readable media such as RAMs, ROMs, flash memory, EEPROMs, optical devices (CD or DVD), hard drives, floppy drives, or any suitable device. The computer-executable component is a processor, but any suitable dedicated hardware device can (alternatively or additionally) execute the instructions.

In one variation, a system comprises of one or more computer-readable mediums (e.g., non-transitory computer-readable mediums) storing instructions that, when executed by the one or more computer processors, cause a computing platform to perform operations comprising those of the system or method described herein such as: filling a management receptacle with water; measuring the water carbon concentration and/or other water conditions; and modifying the water, and dispensing the water.

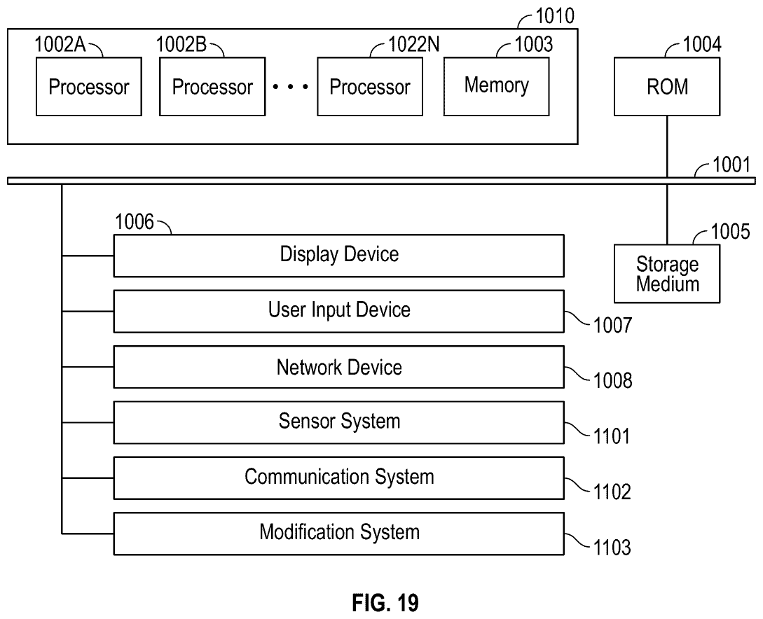

FIG. 19 is an example of a computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

A communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure is used in connecting sensor system 1101, communication system 1102, modification system 1103, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 provides one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions are accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination or any sub-combination, and all of such possibilities are intended to be within the scope of the disclosure.

For the purposes of describing and defining examples herein, it is noted that terms “substantially” or “about” are utilized herein to represent an inherent degree of uncertainty attributed to any quantitative comparison, value, measurement, or other representation. The terms “substantially” and “about,” when utilized herein, represent the degree by which a quantitative representation may vary from a stated reference without resulting in a change in a basic function of the subject matter at issue, such as varying by 0-2% of the quantitative measurement.

As a person skilled in the art will recognize from the previous detailed description and from the figures and claims, modifications and changes can be made to the embodiments of the invention without departing from the scope of this invention as defined in the following claims.

What is claimed is:

1. A system for processing liquid to change an amount of carbon dioxide in the liquid, the system comprising:
a container including an inlet to receive liquid and an outlet to release the liquid, the container for holding the liquid;
one or more sensors coupled to the container to measure carbon content in the liquid that is held in the container; and
a control system including a processor for executing instructions to:
receive outputs of the one or more sensors; and
based on the outputs of the one or more sensors, control dosing of material into the container that reacts with carbon dioxide to change the amount of carbon dioxide in the liquid such that an amount of the material introduced into the container changes over time responsive to changes in the carbon content being measured in the liquid.

2. The system of claim 1, wherein the control system ends introduction of the material into the container based on the material reacting with the carbon dioxide in the liquid and the amount of carbon dioxide in the liquid being below a threshold amount.

3. The system of claim 1, wherein the carbon content in the liquid is a first content, and the control system controls dosing of the material into the container to change the amount of carbon dioxide in the liquid to a second content lower than the first content, and
wherein the control system monitors outputs of the one or more sensors during active introduction of the material into the container to determine when the second content is reached.

4. The system of claim 3, wherein the control system ends introduction of the material into the container based on a target amount of carbon dioxide being removed from the liquid.

5. The system of claim 3, wherein the control system further determines an amount of carbon dioxide captured and stored based on a comparison of the first content and the second content.

6. The system of claim 1, wherein the control system controls opening of the outlet of the container to release the liquid based on the amount of carbon dioxide in the liquid falling below a threshold amount.

7. The system of claim 1, further comprising:
an additive system coupled to the container including a repository of the material to be added into the container.

8. The system of claim 1, wherein the control system determines the carbon content in the liquid once the container is in a closed state, wherein the closed state prevents liquid and airflow into or out of the container.

9. The system of claim 1, wherein:
the container includes an air inlet to enable carbon dioxide to be input into the container to incorporate the carbon dioxide into the liquid within the container.

10. The system of claim 1, wherein:
the container includes an air inlet to enable direct air capture into the container to incorporate gas into the liquid within the container.

11. The system of claim 10, wherein the one or more sensors comprise a first sensor for measuring the carbon content in the liquid, and the system further comprises:
a second sensor for measuring an alkalinity of the liquid in the container; and
based on the alkalinity of the liquid in the container, the control system controls the air inlet to enable the direct air capture into the container to incorporate additional carbon dioxide into the liquid within the container.

12. The system of claim 10, wherein the one or more sensors comprise a first sensor for measuring the carbon content in the liquid, and the system further comprises:
a second sensor for measuring an oxygen level of the liquid in the container; and
based on the oxygen level of the liquid in the container, the control system controls the air inlet to enable the direct air capture into the container to incorporate additional oxygen into the liquid within the container.

13. The system of claim 1, wherein:
the material reacts with the carbon dioxide to dissolve and form bicarbonate products, and
the control system controls dosing of the material such that some of the material is recoverable and the amount of carbon dioxide in the liquid is reduced to a target amount.

14. The system of claim 1, further comprising:
a housing coupled to or including the container, the one or more sensors, and the control system, wherein the housing is at least partially submerged in a source of the liquid.

15. The system of claim 1, further comprising:
a housing coupled to or including the container, the one or more sensors, and the control system, wherein the housing is a floating vessel.

16. A system for processing liquid to change an amount of carbon dioxide in the liquid, the system comprising:
a container including a first inlet to receive liquid into the container and a second inlet to incorporate gas into the liquid within the container;
one or more sensors coupled to the container to measure carbon content in the liquid that is held in the container; and
a control system including a processor for executing instructions to:
receive outputs of the one or more sensors; and
based on the outputs of the one or more sensors, control dosing of material into the container that reacts with carbon dioxide to change the amount of carbon dioxide in the liquid such that an amount of the material introduced into the container changes over time responsive to changes in the carbon content being measured in the liquid.

17. The system of claim 16, wherein the control system ends introduction of the material into the container based on the amount of carbon dioxide in the liquid being below a threshold amount.

18. The system of claim 16, wherein the one or more sensors comprise a first sensor for measuring the carbon content in the liquid, and the system further comprises:
a second sensor for measuring an alkalinity of the liquid in the container; and
based on the alkalinity of the liquid in the container, the control system controls the second inlet to enable direct air capture into the container to incorporate additional carbon dioxide into the liquid within the container.

19. The system of claim 16, wherein the one or more sensors comprise a first sensor for measuring the carbon content in the liquid, and the system further comprises:
a second sensor for measuring an oxygen level of the liquid in the container; and
based on the oxygen level of the liquid in the container, the control system controls the air inlet to enable the direct air capture into the container to incorporate additional oxygen into the liquid within the container.

20. A method for processing liquid to change an amount of carbon dioxide in the liquid, the method comprising:
receiving liquid from a source into a container;
measuring carbon content in the liquid that is held in the container by one or more sensors coupled to the container; and
based on outputs of the one or more sensors, controlling dosing of material into the container that reacts with carbon dioxide to change the amount of carbon dioxide in the liquid such that an amount of the material introduced into the container changes over time responsive to changes in the carbon content being measured in the liquid.

21. The method of claim 20, wherein controlling dosing of material into the container comprises:
a control system including a processor for executing instructions to control operation of a valve of a feeder to release the material from the feeder into the container.

22. The method of claim 21, wherein controlling dosing of material into the container comprises:
the control system including the processor for executing instructions to perform a feedback loop including (i) releasing a first amount of the material from the feeder into the container, (ii) receiving subsequent outputs of the one or more sensors, (iii) determining an updated carbon content in the liquid, (iv) based on the updated carbon content in the liquid being above a threshold amount, releasing a second amount of the material from the feeder into the container.

23. The method of claim 20:
wherein receiving liquid from the source into the container comprises partially filling the container with the liquid to create a filled region containing the liquid and an unfilled region containing air, and
wherein measuring carbon content in the liquid comprises:
measuring, by the one or more sensors positioned in the unfilled region, a carbon content of the air;
measuring, by the one or more sensors positioned in the filled region, properties of the liquid including temperature, salinity, and alkalinity; and
calculating the concentration of carbon in the liquid based on the outputs of the one or more sensors.

24. The method of claim 20, wherein:
receiving liquid from the source into a container comprises receiving the liquid via a first inlet into the container, and
measuring the carbon content in the liquid that is held in the container comprises measuring the carbon content by a first sensor, and
the method further comprises:
measuring alkalinity of the liquid in the container by a second sensor; and
based on the alkalinity of the liquid in the container, controlling a second inlet of the container to enable direct air capture into the container to incorporate additional carbon dioxide into the liquid within the container.

25. The method of claim 20, wherein the container includes an inlet to receive the liquid and an outlet to release the liquid, and the method further comprises:
based on the outputs of the one or more sensors, controlling opening and closing of the inlet and the outlet to control a flow rate of the liquid into and out of the container.

26. The method of claim 20, wherein the container includes an inlet to receive the liquid and an outlet to release the liquid, and the method further comprises:
based on the outputs of the one or more sensors, controlling opening and closing of the inlet and the outlet to control a duration of the liquid in the container.
